(19) United States
(12) Patent Application Publication
(10) Pub. No.: US 2008/0276976 A1
(43) Pub. Date: Nov. 13, 2008

(54) Household Device, in Particular Dishwasher

(75) Inventors: Kai Buller, Glandorf (DE); Guenther Ennen, Enger (DE); Seyfettin Kara, Spenge (DE); Martin Kornberger, Bielefeld (DE); Monika Seifert, Detmold (DE)

Correspondence Address: DARBY & DARBY P.C., P.O. BOX 770, Church Street Station, New York, NY, 10008-0770, US

(73) Assignee: Miele & Cie. KG, Guetersloh (DE)

(21) Appl. No.: 11/917,616

(22) PCT Filed: May 11, 2006
(86) PCT No.: PCT/EP06/04413

§ 371 Date: Dec. 14, 2007

(30) Foreign Application Priority Data
Jun. 14, 2005 (DE) 10 2005 027 572.9

(51) Int. Cl. B08B 3/04; G06F 3/041; B08B 3/00

(52) U.S. Cl. 134/56 D; 345/173; 134/113

(57) ABSTRACT

A dishwasher includes a washing container, which can be closed by a pivotable door and a control panel. The control panel is disposed on the pivotable door and includes a glazed surface and at least one of a control clement and a display element disposed behind the glazed surface and activatable by touching the glazed surface. The glazed surface is optically switchable so as to change its optical properties between transparent and opaque.

### CROSS REFERENCE TO RELATED APPLICATIONS

This is a U.S. national phase application under 35 U.S.C. § 371 of International Patent Application No. PCT/EP2006/004413, filed May 11, 2006, and claims benefit of German Patent Application No. 10 2005 027 572.9, filed Jun. 14, 2005. The International Application was published in German on Dec. 21, 2006 as WO 2006/133778 A1 under PCT Article 21(2).

### FIELD

The present invention relates to a household appliance, in particular a dishwasher, including a washing tub which can be closed by a pivotable door, and a control panel in which control elements are arranged behind a glazed surface and can be activated by touching the surface.

### BACKGROUND

In dishwashers, the dishes and cutlery are loaded and unloaded from the front. The control elements are accessible from the front of the door, so that the control elements can be operated once the pivotable door is closed. In dishwashers, said control elements and the display are located in the upper half of the dishwasher door. Thus, they are permanently accessible and visible to the user. The latter also applies to other household devices. German Patent Application DE 103 26 948 A1, for example, describes such a control panel for a washing machine.

This way of arranging the control elements is considered to have the disadvantage that the control elements impair the appearance of an appliance that is framed by cabinets of a kitchen cabinet front. It is also believed to be a disadvantage that the control elements tend to become soiled due to frequent use and that they are often difficult to clean. Another problem resides in the openings required for the controls. In particular in water-using household appliances, such openings allow moisture to get inside the appliance, where it may cause damage to the electrical and electronic components located there.

U.S. Patent Application 2005/0078027 A1 describes so-called touch screens, in which the control elements are located behind a glass surface and provided with sensors which detect a touch of the glass surface in the area of the respective control element and which then issue a control command to a controller.

German Patent Application DE 101 17 905 A1 describes a household appliance having a display device in which all indicators are arranged on a material layer that can be electrically influenced pixel by pixel, which allows the indicators to be activated as needed.

U.S. Pat. No. 5,589,958 A describes kitchen furniture and appliances in which the optical properties of the windows can be changed between transparent and opaque.

### SUMMARY

It is an aspect of the present invention to improve a household appliance such that a control panel blends better with a door front and, at the same time, to make the control panel significantly easier to clean.

In an embodiment the present invention provides a household appliance. The household appliance includes a washing tub, a pivotable door and a control panel disposed on the pivotable door. The pivotable door is configured to close the washing tub. The control panel includes a glazed surface and at least one of a control element and a display element disposed behind the glazed surface and activatable by touching the glazed surface. The glazed surface is optically switchable so as to change an optical property thereof between transparent and opaque.

### BRIEF DESCRIPTION OF THE DRAWINGS

Aspects of the present invention will now be described by way of exemplary embodiments with reference to the following drawings, in which:

FIG. 1 is a perspective view showing part of an upper portion of a dishwasher according to an exemplary embodiment of the present invention;

FIG. 2 is a cross-section through the control panel 2 of the dishwasher of FIG. 1;

FIG. 3 is a view showing the control panel in transparent and opaque states.

### DETAILED DESCRIPTION

Many advantages are derived by the fact that the control panel occupies a glazed surface that is optically switchable between transparent and opaque. By making the control elements invisible, the dishwasher has a higher-quality appearance. Moreover, since the control panel has a smooth surface, it is much easier to clean.

In an exemplary embodiment, the optically switchable, glazed surface interacts with a user-activatable switch, so that the user himself or herself can determine the time at which to activate the control elements. If the switch is designed as a proximity switch, the ease-of-use is further increased. Thus, when a user approaches the appliance, the glazed surface becomes transparent, so that the individual control elements are visible. In addition, the optically switchable, glazed surface may also interact with the central controller of the dishwasher so as to indicate to the user the current program status of the appliance in accordance with the program steps.

The individual control elements can be designed in the manner of a touch screen, so that the individual program steps can be selected by the touch of a finger. In addition to switching the glazed surface to a transparent state, it is also expedient to activate a lighting device, making it easer for the user to select the individual control elements.

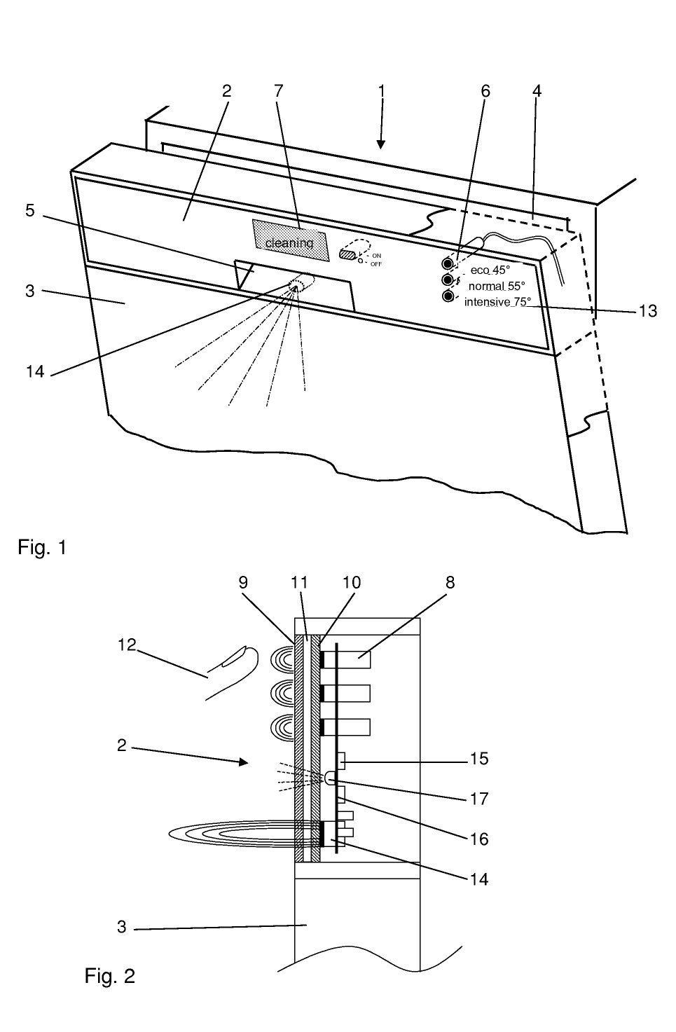

FIG. 1 illustrates a household appliance designed in accordance with an exemplary embodiment of the present invention and including a control panel 2, using the example of a dishwasher 1. In dishwasher 1, control panel 2 is located in the upper portion of a door 3, which is pivotably mounted in the lower portion of dishwasher I and serves to close the close washing tub 4 of the appliance. Door 3 is closed using a handle 5, which is also located in the area of control panel 2.

Control panel 2 is provided with control elements 6 which can be used to turn on the appliance and to select a program. Other elements may be used to select additional or other functions. Moreover, the control panel is provided with a display device 7, which can be used to display the program progress of the appliance and, as the case may be, further information for the user. Here too, it is possible to use additional display elements, for example to acknowledge operation of the control elements or to signal an appliance failure or operator error.

In place of the switches conventionally used in the panel, now capacitive or optical sensors 8 are used for program selection (start, preselection, etc.), said sensors being located behind a glass surface (9 through 11); see also FIG. 2 in this regard. This allows user control to be carried out in the manner of a touch screen and eliminates the need for openings in panel 2, which makes it easier to clean it. Capacitive sensors are responsive to changes in the dielectric in the area immediately surrounding them. Thus, when a finger 12 or other object approaches the sensor, the sensor will issue a control command to the appliance controller. Optical sensors frequently have a transmitter or a receiver and are responsive to reflected light beams. The light passes through a transparent panel, hits an obstacle (finger 12), is reflected by the obstacle, and is then sensed by the receiver behind the glass.

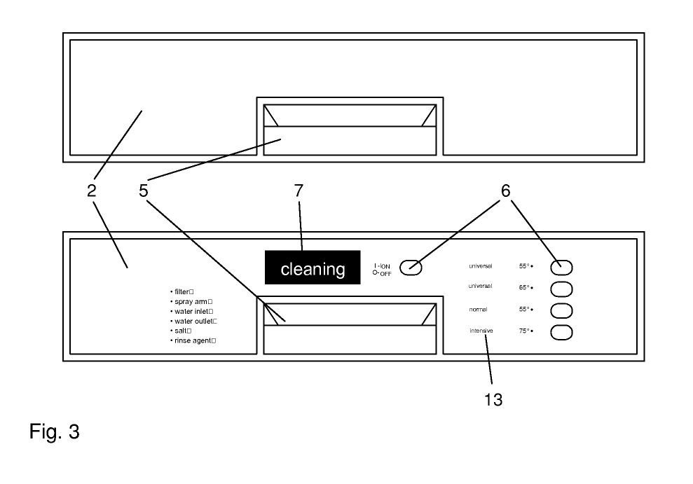

The glazed surface is configured such that it is optically switchable so that, as illustrated by the comparison in FIG. 3, glazed surface (9 through 11) can change from an opaque state (top of FIG. 3) to a transparent state (bottom of the figure). To this end, a switchable glass layer 11 having electrochromic, gasochromic, hydrochromic, photochromic or photoelectrochromic properties is mounted between an outer protective layer 9 made of normal transparent glass and an inner protective layer 10, which is also made of normal transparent glass. Outer protective layer 9 protects in particular the switchable glass layer 11 from external influences. In addition, it is carries symbols and markings, possibly on the rear face thereof, which are intended to be permanently visible and which may include marks or appliance identification information. Inner protective layer 10 is provided with an imprint 13 (see FIG. 1) which serves to label control elements 6. The individual control elements 6 are arranged on the rear face of inner protective layer 10 and are responsive to touches of outer protective layer 9 with the finger.

The switching of switchable glass layer 1 is accomplished by a user-activatable switch located in the area of handle 5. This ensures that the control panel is switched to a transparent state, and thus to an operator control mode, when the user opens the door to pour in detergent. Alternatively, as shown in FIGS. 1 and 2, a proximity switch 14 may be used, so that the user does not need to make any further control input to activate control panel 2. In addition to switch 14, switchable glass layer 11 may also interact with appliance controller 15, so that display device 7 and the display elements can be monitored during certain phases or during the entire program cycle. Moreover, appliance controller 15 may switch to the opaque mode automatically using a timing module, thus saving energy. In order to make it easier for the user to see the control elements 6, control panel 2 has provided therein a lighting device 17 which is activated at the same time as glazed surface (9 through 11) is switched to a transparent state and is deactivated when the glazed surface is switched to an opaque state. In addition, glazed surface (9 through 11) can also be switched to a permanently transparent state.

By default, control panel 2 becomes visible when the user approaches the dishwasher. It is only then that control elements 6 are activated and become responsive to touches of outer protective layer 9.

The mounting position of the proximity or activation switch 14 depends on its operating principle. If switch 14 operates with an optical sensor, it must protrude through switchable glass layer 11. However, if the sensor is responsive to acoustic or electromagnetic signals, it can be located behind switchable glass layer 11, or even behind inner protective layer 10. In that case, the mounting position of the sensor is only determined by the configuration of the control panel.

1-6. (canceled)

7. A household appliance, comprising:
a washing tub;
a pivotable door configured to close the washing tub; and
a control panel disposed on the pivotable door, the control panel including a glazed surface and at least one of a control element and a display element the at least one of a control element and a display element being disposed behind the glazed surface and activatable by touching the glazed surface, the glazed surface optically switchable so as to change an optical property thereof between transparent and opaque.

8. The household appliance recited in claim 7, wherein the household appliance is a dishwasher.

9. The household appliance recited in claim 7, further comprising a user-activatable switch configured to interact with the glazed surface.

10. The household appliance recited in claim 9, wherein the user-activatable switch includes a proximity switch.

11. The household appliance recited in claim 7, further comprising an appliance controller configured to interact with the glazed surface.

12. The household appliance recited in claim 9, further comprising an appliance controller configured to interact with the glazed surface,

13. The household appliance recited in claim 10, further comprising an appliance controller configured to interact with the glazed surface.

14. The household appliance recited in claim 7, wherein the control element includes a touch screen.

15. The household appliance recited in claim 9, wherein the control element includes a touch screen.

16. The household appliance recited in claim 10, wherein the control element includes a touch screen.

17. The household appliance recited in 11 wherein the control element includes a touch screen.

18. The household appliance recited in claim 7, further comprising a lighting device, the lighting device being configured to activate when the glazed surface is switched to a transparent state.

19. The household appliance recited in claim 9, further comprising a lighting device, the lighting device being configured to activate when the glazed surface is switched to a transparent state.

20. The household appliance recited in claim 10, further comprising a lighting device, the lighting device being configured to activate when the glazed surface is switched to a transparent state.

21. The household appliance recited in claim 11, further comprising a lighting device, the lighting device being configured to activate when the glazed surface is switched to a transparent state.

22. The household appliance recited in claim 14, further comprising a lighting device, the lighting, device being configured to activate when the glazed surface is switched to a transparent state.
